(19) United States
(12) Patent Application Publication
(10) Pub. No.: US 2008/0132099 A1
(43) Pub. Date: Jun. 5, 2008

(54) Electric connector

(75) Inventor: Ted Ju, Keelung City (TW)

Correspondence Address: TROXERLL LAW OFFICE PLLC, SUITE 1404, 5205 LEESBURG PIKE, FALLS CHURCH, VA, 22041, US

(73) Assignee: Lotes co., Ltd.

(21) Appl. No.: 11/607,052

(22) Filed: Dec. 1, 2006

(51) Int. Cl. H01R 3/00

(52) U.S. Cl. 439/164

(57) ABSTRACT

An electric connector has an insulating body and a plurality of conductive terminals. The conductive terminal includes a first conductive terminal and a second conductive terminal. The first conductive terminal is made of elastic materials. The second conductive terminal is made of red copper. Comparing to a prior art, the electric conductivity is higher so as to achieve the fast electric signal transmission between electric boards.

### BACKGROUND OF THE INVENTION

(a) Field of the Invention

The present invention relates to electric connectors, and in particular an electric connector with higher electric conductivity.

(b) Description of the Prior Art

Electric connectors of prior art have an upper cover, a seat and a plurality of conductive terminals. The conductive terminals include a first conductive terminal and a second conductive terminal. The second conductive terminal is installed on the seat. The first conductive terminal is installed on the upper cover. The upper cover can rotate relatively with the seat. The structure of the electric connector the prior art is formed by connecting a fixing terminal (e.g. the second conductive terminal) and a connecting terminal (e.g. the first conductive terminal) able to move elastically so as to achieve the electric conductivity between the electric boards. However, the two conductive terminals are usually made of the same material of copper alloy, such as phosphorous-copper. Although, the copper alloy is cheaper, the electric conductivity is only 20% IACS above. Another example, special copper is a reasonable price and the electric conductivity thereof is not good enough about from 40% to 60% IACS above.

Besides, although beryllium-copper has a better electric conductivity about 80% IACS above, the price thereof is expensive. The electric connector made of beryllium-copper is not a signal terminal, but combined by two conductive terminals. During the process of conductive connection, contact impedance may reduce the whole electric conductivity so as to reduce an electric function.

Therefore, it is necessary to have a new style electric connector so as to overcome the above-mentioned defects.

### SUMMARY OF THE INVENTION

The primary objective of the present invention is to provide an electric connector with a new style. The electric connector has a first conductive terminal and a second conductive terminal. The first conductive terminal is made of elastic materials. The second conductive terminal is made of red copper. The electric conductivity between the first conductive terminal and the second conductive terminal is higher so as to achieve the fast electric signal transmission between electric boards.

To achieve above object, the present invention provides an electric connector comprising: an insulating body; a plurality of conductive terminals; the conductive terminals including a first conductive terminal and a second conductive terminal; the first conductive terminal being made of elastic material; and the second conductive terminal being made of red copper.

### BRIEF DESCRIPTION OF THE DRAWINGS

FIG. 1 is an assembled perspective view of the electric connector of the present invention.

FIG. 2 is an exploded perspective view of the upper cover and the seat of the electric connector of the present invention.

FIG. 3 is an exploded perspective view of the other angle of the upper cover and the seat of the electric connector of the FIG. 2.

FIG. 4 is an exploded perspective view of the electric connector of the present invention.

FIG. 5 is an exploded perspective view of the other angle of the electric connector of the FIG. 4.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

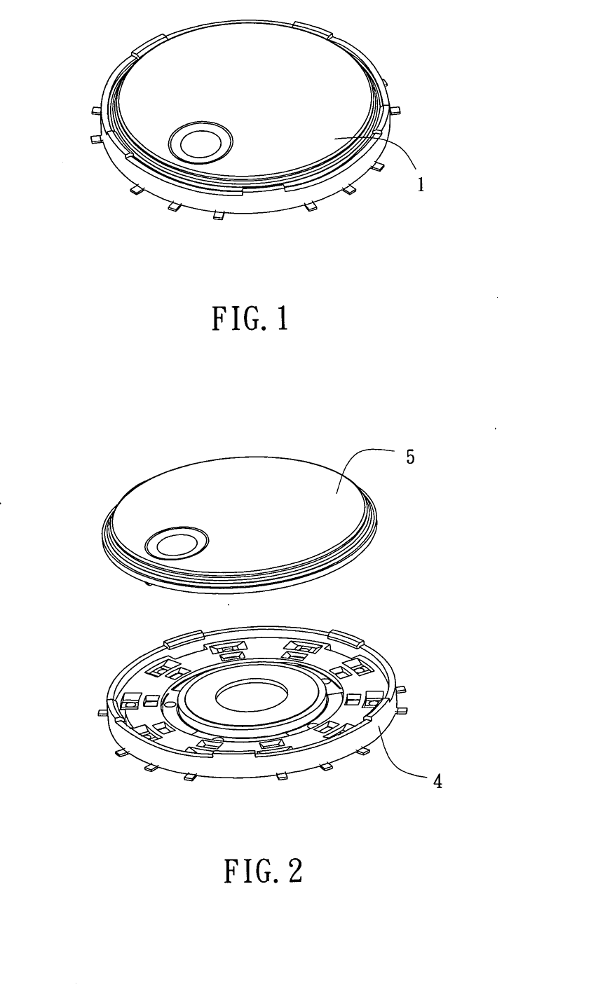

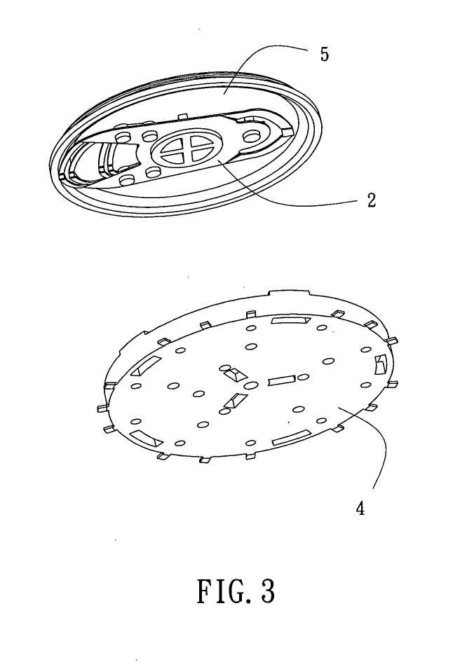

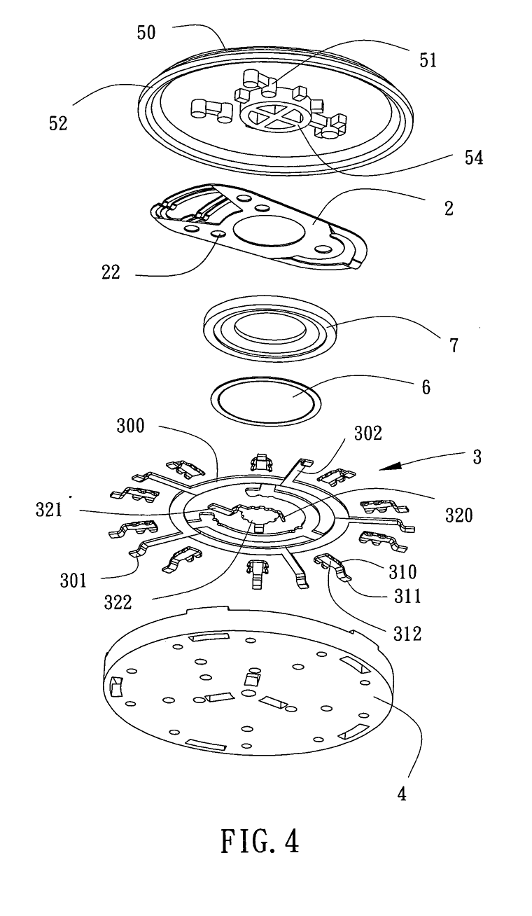

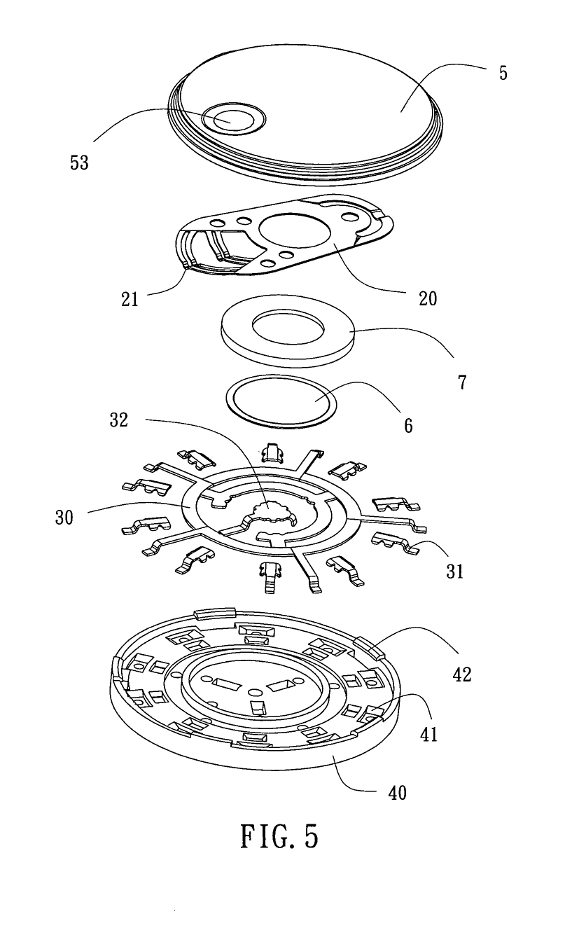

Referring to FIG. 1 to 5, the electric connector of the present invention has an insulating body 1, a first conductive terminal 2 and a second conductive terminal 3. The first conductive terminal 2 and the second conductive terminal 3 can be connected elastically each other. The insulating body 1 is formed by two corresponding devises being installed together. The embodiment of the present invention includes a seat 4 and an upper cover 5. The seat 4 and the upper cover 5 can be rotated relatively. The first conductive terminal 2 and the second conductive terminal 3 is not positioned at the same receiving chambers. The first conductive terminal 2 is installed with the upper cover 5. The second conductive terminal 3 is installed with the seat 4. The first conductive terminal 2 is made of the elastic material (the embodiment is made of copper alloy with higher tensile strength and elasticity). The second conductive terminal 3 is made of pure copper with higher electric conductivity and lower tensile strength and elasticity. The first conductive terminal 2 is elastically contact with the second conductive terminal 3.

The shape of the first conductive terminal 2 is not the same as the second conductive terminal 3. At least one of the conductive terminals has a retaining portion, a contact portion able to connect with an exterior electric unit and a contract portion able to be contact with the other conductive terminal. In the embodiment, the second conductive terminal 3 has a circular main conductive terminal 30 and a subordinate conductive terminal extending from the outside of the circular main conductive terminal 30. The circular main conductive terminal 30 has a first retaining portion 300, a first conductive portion 301 and a first contact portion 302. The first conductive portion 301 can be connected electrically with an exterior electric unit. The first contact portion 302 extends from the first conductive portion 301. The subordinate conductive terminal has a first subordinate conductive terminal 31 positioned at the outside of the circular main conductive terminal 30 and a second subordinate conductive terminal 32 positioned at the inner side of the circular main conductive terminal 30. The first subordinate conductive terminal 31 has a second retaining portion 310, the second conductive portion 311 able to be connected electrically with a exterior electric unit, a second contact portion 312 extending from the second conductive portion 311. The second subordinate conductive terminal 31 has a second retaining portion 320, the second conductive portion 321 able to be connected electrically with a exterior electric unit, a second contact portion 322 extending from the second conductive portion 321.

The first conductive terminal 2 has a main body 20, a elastic portion 21 extending from the main body 20 able to be resist elastically to the contact portion. The first conductive terminal 2 can be moved at level direction and be acted elastically at the vertical direction so as to carry out the elastic electric contact of the second conductive terminal 3.

The seat 4 has a main body 40 and a receiving slot 41. The receiving slot 41 can receive the second conductive terminal 3. The upper cover 5 has a main body 50 and fixing portion 51. The fixing portion 51 extends from the main body 50 able to fix the first conductive terminal 2. Correspondingly, the seat 4 has a protrusion 42 matching to the protruding portion 52 so as to connect rotationally with the seat 4. The seat 4 is integral to the body of the second conductive terminal 3. The electric connector also has an elastic circle 6 and a fixing position unit 7. The elastic circle 6 is installed on the seat 4 able to resist against the second conductive terminal 3. The fixing position unit 7 can fix the fixing circle 6. The elastic circle 6 can resist against the second subordinate conductive terminal 32. The upper cover 5 has a removing portion 53 and a pressing portion 54. The removing portion 53 can rotate the upper cover 5 so that the elastic portion 21 of the first conductive terminal 2 can resist elastically against the connecting portion 113 of the second conductive terminal 3 for achieving the electric conductivity. Besides, the pressing portion 54 can press against the elastic circle 6 so that the elastic circle 6 can press against the second subordinate conductive terminal 32 for achieving the electric conductivity.

The electric connector can be guaranteed to have a higher electric conductivity, because the conductive terminals are made of various materials. Besides, the electric connector has several advantages, such as having a better elastic connection among the conductive terminals, a more convenient operation and a fast signal transmission between electric boards.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. An electric connector comprising:
an insulating body;
a plurality of conductive terminals;
the conductive terminals including a first conductive terminal and a second conductive terminal;
the first conductive terminal being made of elastic material; and the second conductive terminal being made of red copper,
wherein the first conductive terminal is made of a copper alloy, wherein the insulating body is formed by two devises being installed at relative positions, the insulating body having a seat installed with the second conductive terminal and an upper cover installed with the first conductive terminal, and the upper cover can be rotated relatively with the seat.
wherein the seat has a main body and a receiving slot installed on the main body able to receive the second conductive terminal.
wherein the upper cover includes a main body and a fixing portion extending from the main body able to fix the first conductive terminal, the first conductive terminal having a matching portion correspondingly so as to match un the fixing portion.

2. The electric connector as claimed in claim 1, wherein the shape of the first conductive terminal is different from the second conductive terminal.

3. The electric connector as claimed in claim 1, wherein the first conductive terminal is received in a different receiving chamber of the second conductive terminal.

4. The electric connector as claimed in claim 1, wherein the second conductive terminal is rigid.

5. The electric connector as claimed in claim 1, wherein the first conductive terminal is elastically in contact with the second conductive terminal.

6. The electric connector as claimed in claim 1, wherein the second conductive terminal is positioned under the first conductive terminal.

7. The electric connector as claimed in claim 1, wherein the first conductive terminal is movable at a horizontal direction.

8. The electric connector as claimed in claim 1, wherein the first conductive terminal can be acted elastically at the vertical direction.

9. (canceled)

10. The electric connector as claimed in claim 1, wherein one end of second conductive terminal is welded with an exterior electric unit.

11. The electric connector as claimed in claim 1, wherein at least one of the conductive terminals has a removing portion, a conductive portion able to be connected with an exterior electric unit, a contact portion able to be in contact with the other conductive terminal.

12. The electric connector as claimed in claim 1, wherein the second conductive terminal has a circular main conductive terminal.

13. The electric connector as claimed, in claim 12, wherein the second conductive terminal has a subordinate conductive terminal positioned at the lateral side of the circular main conductive terminal; and the subordinate conductive terminal has a connecting portion and a contact portion extending from the connecting portion.

14. The electric connector as claimed in claim 1, wherein the first conductive terminal includes a main body and a elastic portion extending from the main body able to resist elastically against the contact portion.

15-17. (canceled)

18. The electric connector as claimed in claim 1, wherein the upper cover has a protruding portion protruding out from the outside circle of upper cover; and the seat has a protrusion for matching up the protruding portion.

19. The electric connector as claimed in claim 1, wherein the seat is integral body with the second conductive terminal.

20. The electric connector as claimed in claim 1, wherein the electric connector has a elastic circle installed on the seat able to resist against the second conductive terminal and a fixing portion able to fix the elastic circle.

21. The electric connector as claimed in claim 1, further comprising a pressing portion extending from a center of the upper cover through the first conductive terminal.
